(19) United States
(12) Patent Application Publication
(10) Pub. No.: US 2012/0240594 A1
(43) Pub. Date: Sep. 27, 2012

(54) METHOD AND APPARATUS FOR PROTECTING AIRCRAFT ENGINES AGAINST ICING

(75) Inventor: Pavel SHAMARA, Melville, NY (US)

(73) Assignee: COX & COMPANY, INC., Plainview, NY (US)

(21) Appl. No.: 13/190,965

(22) Filed: Jul. 26, 2011

Related U.S. Application Data
(63) Continuation of application No. 13/071,060, filed on Mar. 24, 2011, now abandoned.

(51) Int. Cl. F02C 6/04

(52) U.S. Cl. 60/782; 60/39.093

(57) ABSTRACT

An aircraft engine generates engine power by burning hydrocarbon fuel such as Jet-A. A minute quantity of the fuel is burned in such a manner as to generate no engine power, and the heat generated by the burning fuel is used to protect a region of a surface of a component of an aircraft. In one application, burner assemblies are located inside the splitter of a turbofan engine and the heat generated is used to deice or anti-ice the splitter and the inlet guide vanes of the engine. In another application, burner assemblies are located in an engine nacelle to deice or anti-ice the leading edge of the nacelle.

### BACKGROUND OF THE INVENTION

The invention relates to ice-protection, and more particularly relates to ice-protection for aircraft engines. In its most immediate sense, the invention relates to ice-protection for jet engines such as are used in commercial aviation.

Most commercial jet engines are of the turbofan type. When a conventional turbofan engine enters icing conditions, ice accretes on engine surfaces subject to cold airflow, such as the splitter and the inlet guide vanes. Such ice accretion can reduce the volume of air entering the engine and can also introduce turbulence in the incoming airstream, potentially causing the engine to stall. Furthermore, when the accreted ice breaks off and is ingested in the engine, engine parts can be physically damaged. Additionally, if sufficiently large quantities of ice are ingested, the engine can flame out, causing a complete loss of power.

While a turbofan engine can be designed so that ingestion even of large amounts of ice will not cause damage or loss of engine power, such engines have reduced fuel economy. But, fuel costs are an important consideration for airlines, and airlines therefore require engines that consume fuel economically. For this reason, turbofan engines require ice-protection.

One conventional ice-protection technology employed for commercial turbofan engines uses so-called “bleed air”. In this technology, high-temperature compressed air is “bled off” from the engine's high pressure compressor and routed to the region(s) where ice accretes. This either melts accreted ice before the accretion becomes unacceptably large (deicing mode) or prevents ice from forming (anti-icing mode).

Bleed air technology has two serious drawbacks. First, it reduces engine efficiency; air taken from the high pressure compressor reduces the thermodynamic cycle efficiency of the engine. Second, the engine must be operated at higher power when in icing to compensate for the power used by the bleed air system. These two factors lead to increased fuel consumption.

Another conventional ice-protection technology for this application is electro-thermal heating. In an electro-thermal system, an electric heater is mounted to the surface to be protected such as the splitter, and is used in a deicing mode or in an anti-icing mode.

An electro-thermal ice-protection system has its own drawbacks. All modern commercial aircraft require electrical power to operate the many electrical and electronic systems (e.g. engine and aircraft control systems, navigation systems, lighting, ventilation systems) on the aircraft, and electro-thermal ice-protection systems present a substantial additional electrical load on onboard power generation equipment. The additional electrical power can be provided only by substantially larger and heavier power generation equipment, which necessarily imposes a substantial additional load on the aircraft engines. Thus, electro-thermal ice-protection systems are also not fuel-efficient.

Other technologies for protecting turbofan engines against icing—use of “icephobic” coatings upon which ice cannot easily form, use of the heat from the engine oil, use of ultrasound, use of electromagnetic radiation—have been investigated, but to date none have been satisfactory. It would therefore be advantageous to provide a method and apparatus that could be used to protect aircraft and aircraft components—particularly turbofan engines, but other components as well—from icing.

One object of the invention is to provide method and apparatus that can be used to protect a jet engine (particularly a turbofan engine) against icing without adversely affecting fuel efficiency.

Another object is to provide such a method and apparatus that does not substantially add to the weight of the aircraft.

Still another object is to provide such a method and apparatus that is simple and can be incorporated into a conventional jet engine—and particularly into a conventional turbofan engine—without substantial modification.

Yet another object is, in general, to improve on known ice-protection technologies used on aircraft.

### SUMMARY OF THE INVENTION

The invention proceeds from a realization that the fuel (normally but not necessarily Jet-A fuel) used in commercial aircraft can be used in a novel manner. Jet-A fuel has a specific energy of 43 MJ/kg. Thus, burning even a small amount of Jet-A fuel can generate substantial heat.

In accordance with the invention, the hydrocarbon fuel used in an aircraft is burned in such a manner as to produce no engine power, i.e. the combustion of the fuel does not power a shaft engine (such as a conventional internal combustion engine) or a reaction engine (such as a conventional turbine or turbofan engine) and the heat thereby produced is routed to the surface region that is to be protected from excessive accretion of ice. This can be accomplished by routing a fuel line to the place where the to-be-protected surface region is located and siting a burner to a position where it will deliver to this surface region the heat produced by burning.

In one preferred embodiment, the fuel is burned inside the splitter of a turbofan engine. Because the burning of the fuel releases so much heat, only a tiny quantity of fuel is required.

Advantageously, and in this preferred embodiment, inlet guide vanes of the turbofan engine are ice-protected using elongated thermally conductive elements. Each such element is embedded within the inlet guide vane to be ice-protected and projects into the splitter. The element, which advantageously but not necessarily is made of copper or high order pyrolytic graphite, transfers the heat created by burning fuel inside the splitter into the protected inlet guide vane.

In this preferred embodiment, the splitter is hollow and a plurality of burner assemblies are located inside it. Each burner assembly includes an air intake, a fuel intake, a nozzle for creating a spray of fuel, an igniter (such as a sparkplug or a glow plug), and an exhaust outlet. In operation, air and fuel are directed into the burner assembly, an air-fuel mixture is created and then ignited by the igniter, and exhaust gas is exhausted through the exhaust outlet.

In an alternate embodiment, an exterior aircraft surface, such as the surface of an engine nacelle, is protected from icing by employing a plurality of burner assemblies that, while perhaps differently dimensioned from those used to protect the engine, have identical functionality.

### BRIEF DESCRIPTION OF THE DRAWINGS

The invention will be better understood with reference to the following illustrative and non-limiting drawings, in which:

FIG. 1 is a schematic illustration of a turbofan engine;

FIG. 2 is a schematic illustration of a first preferred embodiment of the invention;

FIGS. 3 and 3A are enlarged and more detailed views of the first preferred embodiment;

FIG. 4 is a schematic illustration of a second preferred embodiment of the invention; and

FIG. 5 is a flow chart illustrating the operation of a preferred embodiment of a method in accordance with the invention; and

FIG. 6 is a more detailed illustration of a part of the first preferred embodiment.

### DETAILED DESCRIPTION OF PREFERRED EMBODIMENTS

In all the Figures, the same element is always indicated by the same reference numeral. The drawings are not to scale, and certain elements may be enlarged or eliminated for clarity. Corresponding elements in different embodiments have primed reference numerals.

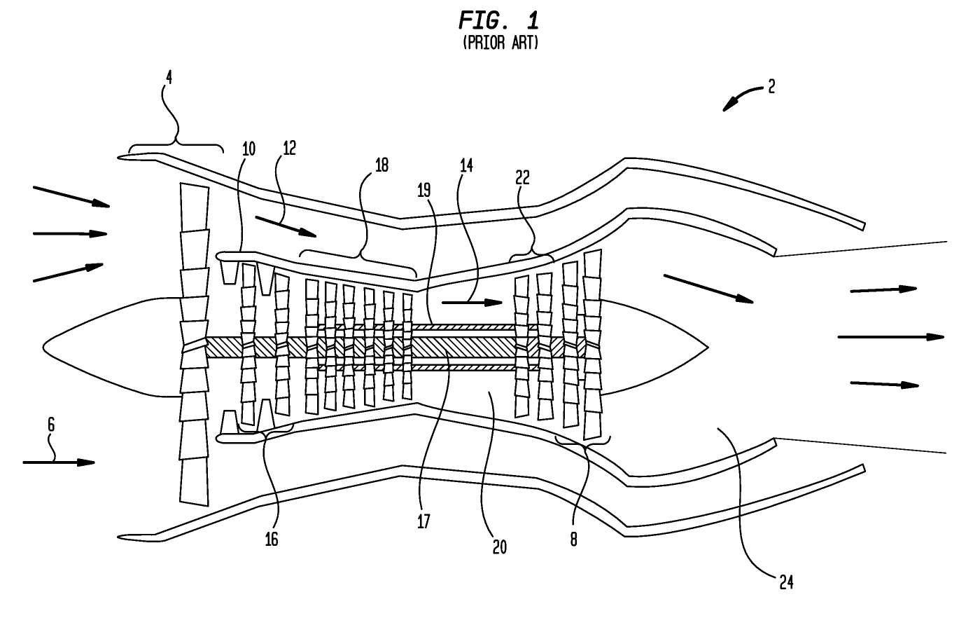

In the following description, the preferred embodiment is illustrated as employed in a conventional turbofan engine 2. This is because most commercial jet engines are of the turbofan type. However, the invention can be adapted to a turboprop or a turbojet. In a conventional turbofan engine such as is schematically illustrated in FIG. 1 and generically indicated by reference numeral 2, a fan 4 draws the intake airstream into the engine inlet generally indicated by reference numeral 6. The fan 4 is driven by a low-pressure turbine generally indicated by reference numeral 8 and described in more detail below.

Once intake air has entered the engine inlet 6, it is split by a splitter generally indicated by reference numeral 10 into a high-volume bypass airstream 12 and a lower volume core airstream 14. The bypass airstream 12 is passed directly through the engine 2 and creates most of the thrust generated by the engine 2, while the core airstream 14 is used to create engine power by supplying oxygen for combustion as will now be described in more detail.

The core airstream 14 enters a low-pressure compressor generally indicated by reference numeral 16, where the pressure of the air in the core airstream 14 is raised. In a subsequent compression carried out by a high-pressure compressor 18, the pressure of the air in the core airstream 14 is raised once again and the high-pressure air is introduced into the combustion chamber 20 to be mixed there with injected Jet-A fuel (not shown). This fuel-air mixture is then burned in the combustion chamber 20. This combustion creates a gas at high temperature and high pressure, and this hot high-pressure gas drives a high pressure turbine 22 (that powers the high-pressure compressor 18 via a hollow cylindrical shaft 19) as well as the low-pressure turbine 8 (that powers the fan 4 and the low-pressure compressor 10 via a shaft 17). Exhaust gas exits the engine 2 through the nozzle 24, adding to the thrust generated by the bypass airstream 12 to propel the aircraft (not shown). To summarize, in a conventional turbofan engine 2, a high-pressure compressor 18 feeds high-pressure air into a combustion chamber 20 where Jet-A fuel is burned, creating hot, high-temperature gas that provides power for the engine. This gas drives a high-pressure turbine 22 and a low-pressure turbine 8. The high-pressure turbine 22 drives a high-pressure compressor 18, and the low-pressure turbine drives a fan 4 and a low-pressure compressor 16. The fan 4 inducts a high-volume bypass airstream 12 into the engine 2, and this bypass airstream 12 provides most of the thrust that propels the aircraft. The fan 4 also inducts a lower volume core airstream 14 that is compressed and used to support combustion in the combustion chamber 20 to produce engine power.

As can be seen in FIG. 1, a conventional turbofan engine 2 also utilizes inlet guide vanes 28. The inlet guide vanes 28 are fixed to the core side of the splitter 10 forward of the blades 26, and are inclined with respect to the axis of the engine 2 to guide the core airstream 14 along directions consistent with the rotation of the blades 26.

When the engine 2 is used in icing conditions, ice accretes on the leading edge of the splitter 10 and on the inlet guide vanes 28. This ice accretion can be of significant concern. At some point, accreted ice will break off the splitter 10 or off one or more of the inlet guide vanes 28, or both, to be ingested into the core of the engine 2. If the accreted ice is in sufficient quantity or is in sufficiently large pieces, it can damage blades of the compressors 16, 18 and even extinguish the combustion in the combustion chamber 20. This latter phenomenon (“flame-out”) is potentially very serious because the engine 2 produces no power until combustion has been restarted and without engine power there is no thrust to keep the aircraft aloft. In the worst case, a flame-out can cause the aircraft to crash.

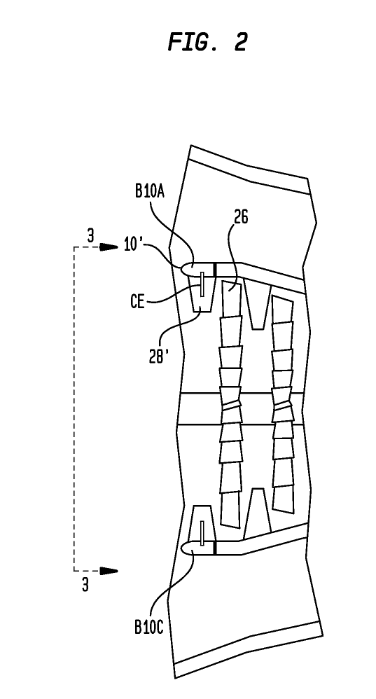

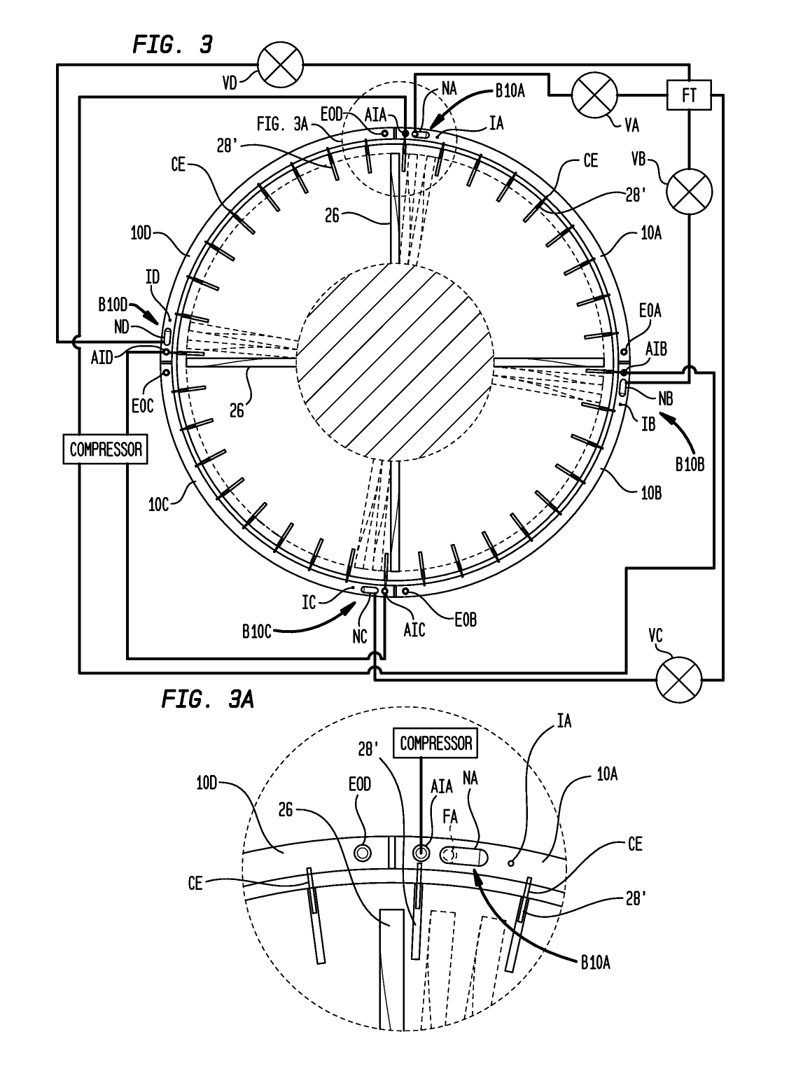

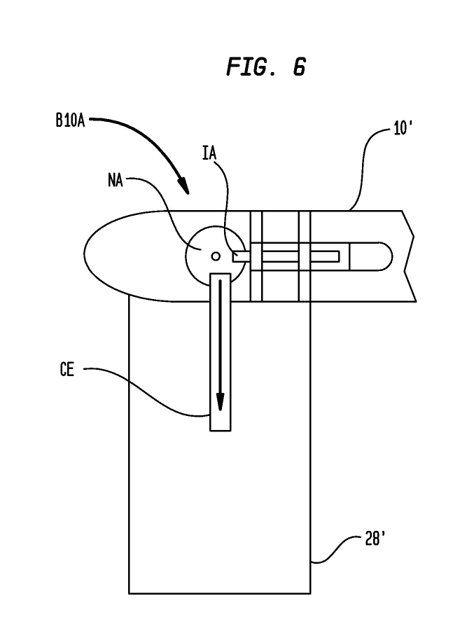

In accordance with a first preferred embodiment of the invention as illustrated in FIGS. 2, 3, and 6, the splitter 10′ is hollow at its forward end and is divided into four identical sectors 10A, 10B, 10C, and 10D. (The number of sectors is not part of the invention, the choice to illustrate the preferred embodiment as having four sectors 10A . . . 10D is arbitrary, and the sectors are not necessarily identical. It is presently believed that the number of sectors will be determined by the circumference of the splitter.) Each sector contains a burner assembly B10A, B10B, B10C, and B10D that burns the aircraft fuel without producing power.

As illustrated, the burner assemblies B10A . . . B10D are all identical, and for this reason only burner assembly B10A will be discussed. However, it will be understood that the burner assemblies B10A . . . B10D need not necessarily be identical. At one end of the burner assembly B10A is located an air inlet AIA, a fuel inlet FIA, and an igniter IA. The fuel inlet FIA is connected to one of the aircraft's fuel tanks FT by a valve VA. The valve VA feeds a minute amount of Jet-A fuel to a nozzle NA, which creates a fuel spray for more efficient combustion. The igniter IA can for example be a sparkplug or a glow plug; it is operated by the electrical system (not shown) of the aircraft (not shown). At the other end of the burner assembly B10A is an exhaust outlet EGA for venting exhaust gas out of the sector 10A.

When the burner assembly B10A is operated, compressed air is introduced into the air inlet AIA, the valve VA is turned on to feed fuel to the nozzle NA, and the igniter IA is momentarily operated to ignite the fuel and is turned off once ignition has occurred. The fuel burns without creating engine power, and without affecting the performance or efficiency of the engine 2, and the exhaust gas is ported out of the burner assembly B10A through the exhaust outlet EOA. It will be evident that the heat of combustion will raise the temperature of the splitter 10′. As will be discussed below, the combustion is regulated in accordance with the type of ice-protection required.

As stated above, the burner assemblies B10A . . . B10D are not necessarily identical. For example, a sector might have several burner assemblies, it may not be necessary to provide an igniter (e.g. IA) for each nozzle (e.g. NA), and it may not be necessary to provide an exhaust outlet (e.g. EOA) for each nozzle (e.g. NA). Furthermore, the nozzles need not necessarily be identical; differences in the structure of the splitter 10′ or other factors may make it advantageous to provide different nozzles in different locations. Persons skilled in the art will appreciate that the number and type of components will be dictated by the particular configuration of the intended application for the invention.

In order to protect the inlet guide vanes 28′ from icing, heat from the burner assembly B10A is transferred to the protected inlet guide vanes 28′. (Ordinarily, all the guide vanes 28′ will be protected from icing, but this is not required. It may be adequate to protect only some of the inlet guide vanes 28′. The intended application will determine this.)

To do this, one end of an elongated thermally conductive element CE is embedded in the guide vane 28′, the other end being introduced into the interior of sector 10A. The conductive element CE is advantageously made of copper or a tube of high order pyrolytic graphite, but this is not necessary and other materials could be used instead. It will be evident that heat from the burner B10A will be routed from the interior of the sector 10, through the thermally conductive element CE, and to the protected inlet guide vane 28′.

The thermodynamics of the first preferred embodiment will now be discussed in a general fashion. In a large turbofan engine, the surface area of the leading edge of the splitter may be somewhat greater than 1000 in², and the power density needed to deice the splitter is on the order of 25 W/in². The total amount of energy needed to remove ice from the leading edge of the splitter is approximately 28 kW.

Jet-A fuel has a specific energy of 43 MJ/kg. On the conservative assumption that 75% of the heat generated by burning this fuel will be wasted by escaping the burner assembly through the exhaust outlet without performing any ice-melting function, the amount of Jet-A fuel required to maintain the splitter 10′ ice-free for one hour is only 3.1 gallons. And on the conservative assumption that an aircraft will be in icing conditions for two hours, it follows that only 6.2 gallons of Jet-A fuel will be required for ice-protection of each aircraft engine. And since a typical commercial jet aircraft has two engines, the total worst-case fuel consumption for the preferred embodiment will be approximately 12.4 gallons.

A conventional commercial jet carries many thousands of gallons of Jet-A fuel. A Boeing 767 airplane has a fuel capacity of 24,000 gallons, a Boeing 747 airplane has a fuel capacity of 57,000 gallons, and an Airbus 380 airplane has a fuel capacity of 85,000 gallons. It will therefore be understood that ice-protection using the preferred embodiment of the invention has a negligible fuel cost. Because of this, the preferred embodiment of the invention is superior to bleed air systems. As stated above, a bleed air system not only drains power from the engine, but also reduces its efficiency, therefore increasing its fuel consumption.

Additionally, because of its inherent simplicity, the first preferred embodiment is inexpensive and lightweight. Because of these characteristics, the first preferred embodiment compares favorably with electro-thermal systems, which are more expensive and heavier. As has been stated above, 28 kW will be required to remove ice from the leading edge of the splitter. To provide such a substantial quantity of electrical power requires engine-driven alternators, which are expensive. Furthermore, such alternators are heavy, and they increase aircraft weight and fuel consumption even though they would not be used for more than two hours during each flight.

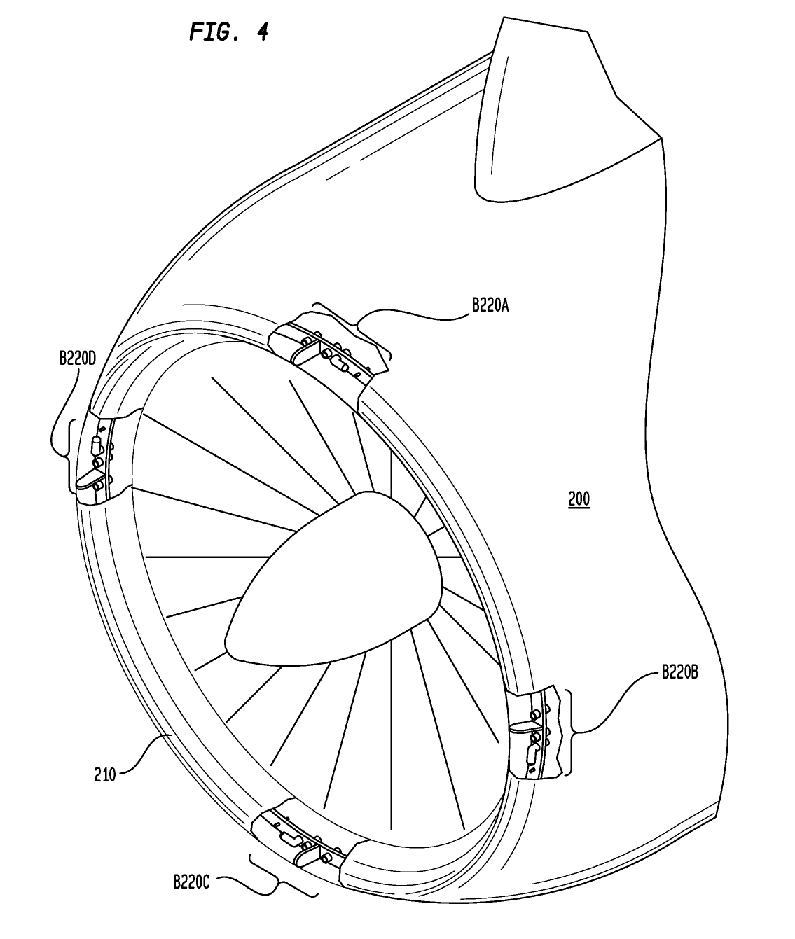

In the second preferred embodiment of the invention as illustrated in FIG. 4, the invention is used to protect the leading edge 210 of an engine nacelle 200. As is shown there, four burner assemblies B220A, B220B, B220C, and B220D are located inside the forward end of the nacelle 200. They operate in the same way as do the burner assemblies B10A, B10B, B10C, and B10D, and no further discussion thereof is considered necessary.

In accordance with the invention, there are two modes of operation for the burner assemblies. In the first, all the burner assemblies are kept operating continuously while the aircraft remains in icing conditions. This mode of operation is called “anti-icing mode” because the surface(s) to be protected (the splitter 10′ and inlet guide vanes 28′ in the first preferred embodiment, and the leading edge 210 of the engine nacelle 200 in the second embodiment) is or are maintained at a temperature that prevents ice from forming on it or on them.

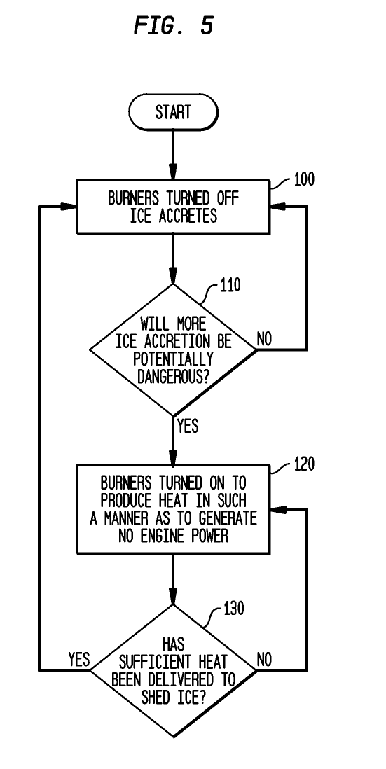

In the second mode of operation, which is known as the “deicing mode” and is schematically illustrated in FIG. 5, the burner assemblies are not continuously operated during icing conditions. Rather, they are initially turned off (step 100), allowing ice to accrete upon the protected surface(s) (e.g. the splitter 10′ and inlet guide vanes 28′, the leading edge 210 of the engine nacelle 200, or any other surface that is to be protected). Ice accretion is permitted to continue until further ice accretion can potentially be dangerous. At this point, the burner assemblies are turned on (step 120) without producing engine power.

Once they have been turned on, the burner assemblies remain on until it has been determined (step 130) that they have delivered to the protected surface(s) a sufficient quantity of heat to shed ice that has accreted upon them. Once this has occurred (i.e. once the accreted ice is assumed to have been blown off e.g. the splitter 10′ and the inlet guide vanes 28′, or off the engine nacelle 200) the burner assemblies are shut off. Ice is then permitted to accrete once again, and the deicing cycle is begun once again.

Tests have been carried out to determine whether the invention can perform under severe conditions. In these tests, a test model was tested in a wind tunnel. The test model was dimensioned to simulate the leading edge of the splitter of a GE90-115B engine. The GE90-115B engine was chosen because it is a large turbofan engine commonly used on wide body airplanes. The dimensions of the splitter of this engine are not known precisely, but were very roughly approximated using publicly available information. Even though the test model does not precisely simulate the structure of a GE90-115B engine with the first preferred embodiment of the invention installed in it (it does not simulate removal of ice from the intake guide vanes), the tests demonstrate to a person skilled in this art that the invention will perform satisfactorily under very severe icing conditions.

In these tests, the test model was subjected to very severe icing conditions, namely:
5 minutes of ice accretion;
total air temperature of −15 F;
airspeed 150 mph;
mean volume droplet diameter of 20 microns; and
liquid water content of 2 grams per cubic meter.

The tests were carried out using kerosene (which is chemically and thermodynamically similar to Jet-A fuel) and using a fuel flow of 0.3 gallons/hour (which is the smallest fuel flow possible using standard oil burner nozzles). Under such severe conditions, when the deicing mode was simulated, it took only 18 seconds to deice the model, and it is estimated that the quantity of fuel required to carry out one deicing cycle on a GE90-115B engine in such severe icing conditions would be on the order of 0.014 gallons.

The anti-icing mode was also simulated under the same conditions, and it is estimated that a GE90-115B engine could be maintained in an anti-iced condition using only 2.7 gallons of fuel for every hour of flying in icing conditions.

Although at least one preferred embodiment of the invention has been described above, this description is not limiting and is only exemplary. The scope of the invention is defined only by the claims, which follow:

1. A method of protecting a turbofan engine against icing, the turbofan engine having a combustion chamber and producing engine power by burning a hydrocarbon fuel in the combustion chamber, comprising the step of burning the fuel outside the combustion chamber.

2. The method of claim 1, wherein the turbofan engine has a splitter and said burning step is carried out inside the splitter.

3. The method of claim 1, further comprising the step of routing heat generated by burning the fuel outside the combustion chamber to engine locations where ice is expected to form.

4. The method of claim 3, wherein said engine locations include the splitter.

5. The method of claim 4, wherein the engine has a plurality of inlet guide vanes, and wherein said engine locations include at least some of the inlet guide vanes.

6. The method of claim 2, wherein said burning step is carried out by using a plurality of burners located inside the splitter.

7. The method of claim 1, wherein said burning step is carried out by using a plurality of burners.

8. Apparatus for protecting, against icing, a jet engine that produces engine power by combustion of a hydrocarbon fuel, comprising: means for burning the fuel inside the engine in such a manner as to generate no engine power.

9. The apparatus of claim 8, wherein the engine is a turbofan engine having a splitter, and wherein the means for burning comprises means for burning the fuel inside the splitter.

10. The apparatus of claim 9, wherein the engine has inlet guide vanes, and further comprising means for delivering heat to at least some of the inlet guide vanes, said heat delivering means comprising a thermally conductive element partially embedded in an inlet guide vane to which heat is to be delivered and extending into the splitter.

11. The apparatus of claim 10, wherein the thermally conductive element is a copper rod.

12. The apparatus of claim 10, wherein the thermally conductive element is an elongated tube of high order pyrolytic graphite.

13. An ice-protected turbofan engine that produces engine power by combustion of a hydrocarbon fuel, comprising:
a splitter;
means for producing heat by burning the fuel in such a manner as to generate no engine power; and
means for delivering the heat to the splitter.

14. The engine of claim 13, further comprising inlet guide vanes, and comprising means for delivering heat to at least some of the inlet guide vanes.

15. The engine of claim 14, wherein said heat delivering means comprises an elongated thermally conductive element embedded in an inlet guide vane to which heat is to be delivered and extending into the splitter.

16. The engine of claim 15, wherein the elongated thermally conductive element is a copper rod with one end embedded in the inlet guide vane and another end extending into the splitter.

17. The engine of claim 15, wherein the elongated thermally conductive element is an elongated tube of high order pyrolytic graphite with one end embedded in the inlet guide vane and the other end extending into the splitter.
